(19) United States
(12) Patent Application Publication
(10) Pub. No.: US 2024/0399890 A1
(43) Pub. Date: Dec. 5, 2024

(54) MULTIFUNCTION CONTROLLER FOR AN ELECTRIC TRAILER

(71) Applicant: Horizon Global Americas Inc., Cleveland, OH (US)

(72) Inventor: Chandrakumar D. KULKARNI, Battle Creek, MI (US)

(73) Assignee: Horizon Global Americas Inc., Cleveland, OH (US)

(21) Appl. No.: 18/678,848

(22) Filed: May 30, 2024

Related U.S. Application Data
(60) Provisional application No. 63/469,631, filed on May 30, 2023.

(51) Int. Cl. B60L 15/20; B60T 8/17

(52) U.S. Cl. CPC B60L 15/2009; B60T 8/1708; B60L 2200/28; B60L 2240/12

(57) ABSTRACT

A controller for an electric trailer is disclosed. A trailer controller assembly includes a force transducer and a controller. The force transducer measures an inter-trailer force between a trailer and a towing vehicle. The controller is communicatively coupled to the force transducer and wheel controllers. The controller includes a brake controller that controls brakes of the trailer. The controller adjust the speed of the trailer using the brake controller and the wheel controllers based on the inter-trailer force.

### CLAIM OF PRIORITY TO PRIOR APPLICATION

This application claims the benefit of the filing date of U.S. Provisional Application Ser. No. 63/469,631, filed on May 30, 2023, entitled “Multifunction Controller for an Electric Trailer”. By this reference the entire disclosure, including the claims and drawings, of U.S. Provisional Application Ser. No. 63/469,631 is hereby incorporated into the present disclosure as though now set forth in its entirety.

### TECHNICAL FIELD

The present disclosure generally relates trailers and, more specifically, a trailer with a controller to control the motive force acting on the trailer.

### BACKGROUND

Modern trailers are both mechanically coupled (e.g., via a hitch, etc.) and electrically coupled (e.g., via a wire harness, etc.) to a towing vehicle. Towed vehicles add weight and are often not very aerodynamic. This increases fuel consumption and/or decreases travel range of the truck on a charge. The towed vehicles also effect driving dynamics for the towing vehicle. These effects can be particularly severe in situations when the towing vehicle needs more horsepower to pull the towing vehicle. For example, increases fuel consumption and/or decreases travel range of the truck on a charge when the towing the trailer up an incline and/or when towing a heavy trailer.

### SUMMARY

As described herein, a trailer controller maintains equilibrium between the thrusting force and the pulling force. Because of the dynamic conditions of towing a trailer, the trailer controller is configured to react to those dynamic conditions such that the trailer controller starts to react to changing conditions, based on its own data about those conditions, before receiving communication from the towing vehicle. The trailer controller is configured to maintain the inter-trailer force within a band defined by an upper threshold for the thrusting force and a lower threshold for the pulling force. The trailer controller maintains an approximately zero inter-trailer force as possible by controlling the service brakes, the electric motors, and the regenerative braking of the trailer. Because the trailer is providing or substantially providing its own motive force, even relatively light vehicles having a low towing capacity and/or a chassis not designed for towing is able to pull disproportionally large and heavy trailers.

A trailer controller assembly includes a force transducer and a controller. The force transducer measures an inter-trailer force between a trailer and a towing vehicle. The controller is communicatively coupled to the force transducer and wheel controllers. The controller includes a brake controller that controls brakes of the trailer. The controller adjust the speed of the trailer using the brake controller and the wheel controllers based on the inter-trailer force.

### BRIEF DESCRIPTION

Operation of the disclosure may be better understood by reference to the following detailed description taken in connection with the following illustrations, wherein:

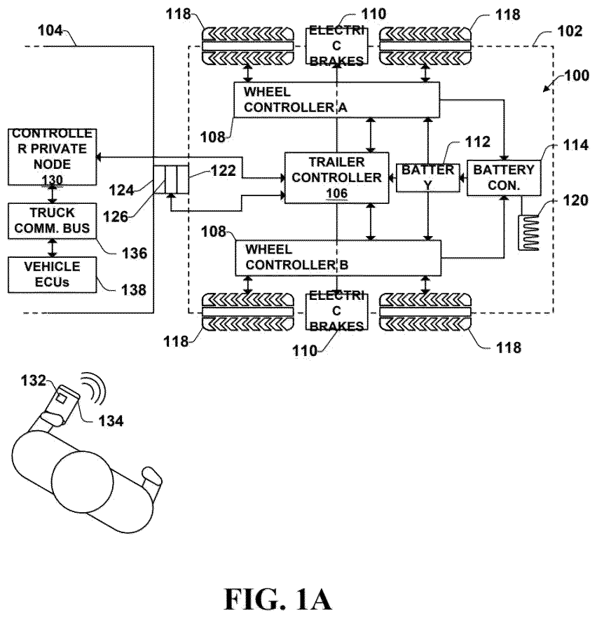

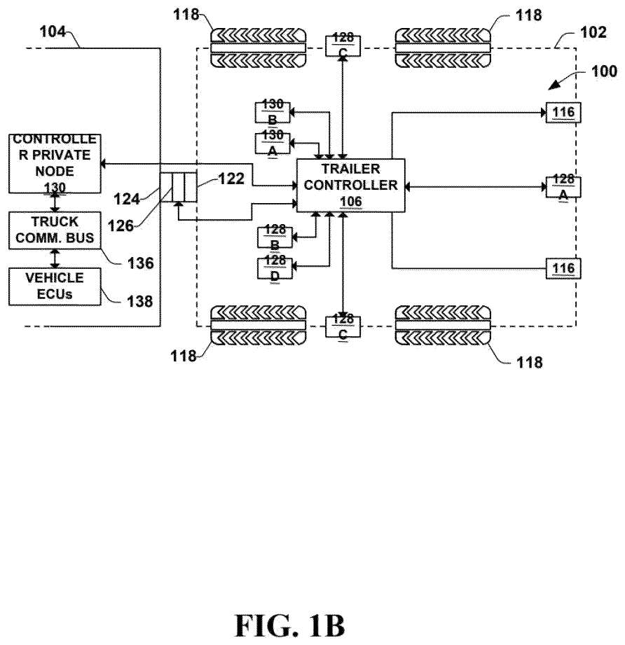

FIGS. 1A and 1B are block diagrams of an electro-mechanical system of an electric trailer, in accordance with the teachings of this disclosure.

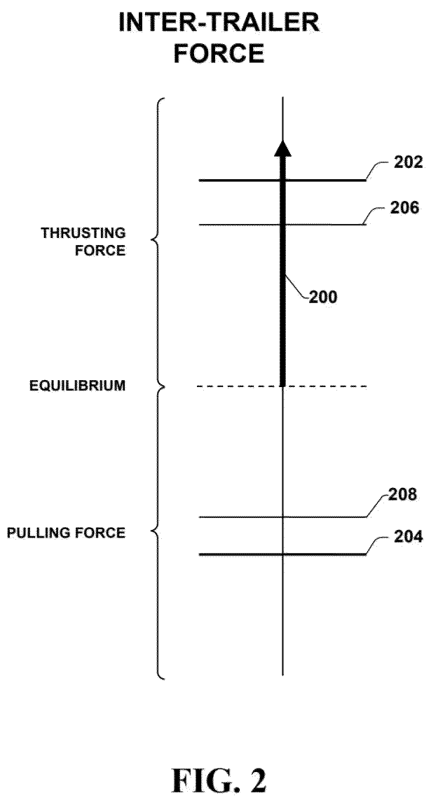

FIG. 2 illustrates a threshold band used by a trailer controller of FIGS. 1A and 1B to control an inter-trailer force, in accordance with the teachings of this disclosure.

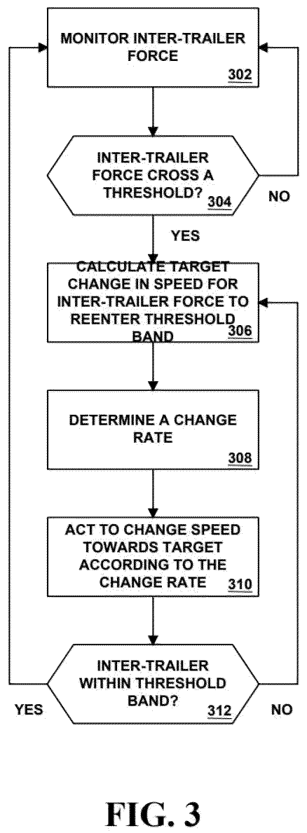

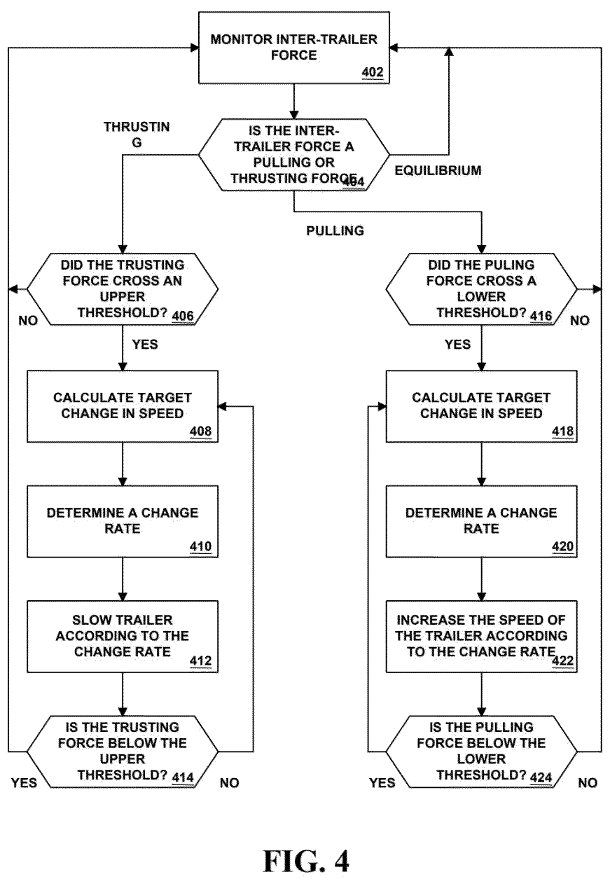

FIGS. 3 and 4 are flowcharts of example methods to control the electric trailer based on an inter-trailer force, in accordance with the teachings of this disclosure.

### DESCRIPTION

Reference will now be made in detail to embodiments of the present teachings, examples of which are illustrated in the accompanying drawings. It is to be understood that other embodiments may be utilized, and structural and functional changes may be made without departing from the scope of the present teachings. Moreover, features of the embodiments may be combined, switched, or altered without departing from the scope of the present teachings, e.g., features of each disclosed embodiment may be combined, switched, or replaced with features of the other disclosed embodiments. As such, the following description is presented by way of illustration and does not limit the various alternatives and modifications that may be made to the illustrated embodiments and still be within the spirit and scope of the present teachings.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

As trailers become more capable as sophisticated, the necessity of robust coordination between the trailer and the towing vehicle increases. Standard seven-wire connections are not configured to be robust enough to handle the volume of communication necessary for such coordination. Additionally, commands generated by the towing vehicle may not take into account the volume of environment, spatial, and motive data, warnings and cautions, status and information related to trailer ecosystem, trailer sway, etc. that is available to a trailer. As such, coordination based on solely on commands from the towing vehicle may provide a less optimal and less responsive experience driving.

Additionally, to improve performance for the towing vehicle, trailers may include electric drivetrains that, at least in part, provide motive force for the trailer. As used herein, a trailer with an electric drivetrain may be referred to as an “electric trailer” or an “electric towed vehicle.” The electric drivetrain may, for example, be used during normal driving to reduce fuel consumption or increase battery life of the electric towing vehicle. In another example, the electric drivetrain of the trailer may be engaged in an assist mode during energy-intensive activities, such as when the towing vehicle and trailer as ascending a hill. This increases the range of the towing vehicle and, in some instances, the ability of the towing vehicle to tow the trailer. However, there is a need for the trailer to communicate with the towing vehicle in order to coordinate forward motion and to increase trailer stability.

Often, the needs of an electric trailer are different from, the needs of a trailer without an electric drivetrain (sometimes referred to as a “conventional trailer” or a “conventional towed vehicle”). For example, when the electric trailer is providing its own motive force, it must coordinate more than lighting and/or braking with the towing vehicle. The electric trailer includes a battery bank. Additionally, the electric trailer includes one or more electric motors to drive the wheels. In some examples, the electric trailer may have an independent drive for each wheel with an integrated control for all wheels. Each wheel may have a wheel speed sensors (such as those disclosed in US Patent Publication No. 2020/0348327, which is incorporated herein by reference). Additionally or alternatively, in some examples, wheel speed sensors may be integrated into the axel with the wheel drive. The electric trailer may include a battery charger to charge the batteries to restore the energy lost during braking.

The trailer controller described below communicates with the towing vehicle and coordinates the motive functions, the safety functions (e.g., stability control, etc.), the lighting functions, and the braking functions, etc. of the conventional trailer. In some examples, when the trailer controller is an electric trailer controller, it communicates with the towing vehicle and also coordinates the motive functions of the electric trailer. In some examples, the towing vehicle includes a towing controller that is configured to cooperate and coordinate with the electric trailer controller. In some examples, towing vehicle includes a towing controller that is configured to communicate with a conventional trailer controller. In some examples, the towing vehicle provides a connection to the vehicle data bus (e.g., the Controller Area Network (CAN) bus, LIN, etc.) to communicatively couple the electric trailer controller to the vehicle data bus.

In some examples, a control module on the towing vehicle and the trailer controller on the trailer may divide processing of the information received from the respective vehicles to control the trailer according to the system described below. For examples, the trailer controller may perform all processing and control (e.g., the control module on the towing vehicle acts as a pass-through device), processing may be functionally divided between the control module and trailer controller (e.g., audiovisual processing by the control module and control processing by the trailer controller, etc.), or processing may be performed by a combination of the control module, the trailer controller, and one or more specialty modules (e.g., separate modules that handle the communication connections, a separate module for audiovisual processing of camera data, etc.). While the trailer controller is described as one module below, the trailer controller may be separated into physically different modules that are communicatively coupled (e.g., via a data bus) to coordinate and perform different tasks (e.g., one module to control the motive functions, one module to perform the diagnostic functions, one module to perform the audiovisual processing, one module to handle the communication connections, etc.).

FIGS. 1A and 1B illustrate an electro-mechanical system 100 of an electric trailer 102 connected to a towing vehicle 104. For understandability, FIGS. 1A and 1B depicts different portions of the electro-mechanical system 100. However, the electro-mechanical system 100 of FIGS. 1A and 1B are two parts that may exist in the same electro-mechanical system 100 as described herein. FIG. 1A illustrates the power and motive control systems of the electro-mechanical system 100. FIG. 1B illustrate other systems of the electro-mechanical system 100. The electro-mechanical system 100 includes a trailer controller 106 that coordinates with and/or reacts to information received from the towing vehicle 104, sensors (e.g., force transducers, gyroscopes, accelerometers, angle sensors, wheel speed sensors, precipitation sensors, battery condition sensors, etc.) on the electric trailer 102, and/or electronics that provide status indicators of parts of the electric trailer 102 (e.g., electronics that relay the status of the coupler (connected or disconnected), the power jack (extended or stowed), the slideout room (deployed or stowed), the power step (deployed or stowed), etc.). In the illustrated example, the electro-mechanical system 100 of the electric trailer 102 also includes wheel controllers 108, electric brakes 110 (sometimes referred to as “service brakes 110”), batteries 112, and a battery controller 114. The electro-mechanical system 100 may also include various lights 116 (e.g., turn signals, brake lights, reverse lights, tail lights, and/or rear fog lamps, etc.), such that the trailer controller 106 may also control the lights 116 of the electric trailer 106 based on light control signals from the towing vehicle 104.

In the illustrated example, the wheel controllers 108 are each connected to two wheels 118. In examples in which the electric trailer 102 includes two wheels, the wheel controllers 108 may each be connected to a single wheel 118. The wheel controllers 108 includes an independent drive for each wheel 118 with components that receive power from the batteries 112 to drive the wheels 118 (e.g., electric motors, power conditioning circuitry, etc.). The electric motors may be brushless DC or PM motors with pulse width modulation (PWM) control for speed control. The wheel controllers 108 also include a wheel speed sensor for each wheel 118. Each of the wheel speed sensors may be a Hall Effect sensor embedded in the drive shaft of the corresponding wheel 118. In the illustrated example, the wheel controllers 108 are communicatively coupled to the trailer controller 106 to receive control signals to control the speed at which the wheels 118 are driven. For example, the wheel controllers 108 may be coupled to the trailer controller 106 via a serial bus, such as a Serial Peripheral Interface (SPI) bus or a Local Interconnect Network (LIN) bus. Alternatively, for example, the components of the electro-mechanical system 100 may be connected together via a wired data bus, such as a CAN bus, and/or a wireless data bus, such as a Bluetooth® connection, a Zigbee® connection, and/or a Wi-Fi® connection, etc.

The brakes 110 are coupled to each of the wheels 118. The brakes 118 are communicatively coupled to the trailer controller 106 to be controlled by the trailer controller 106. The braking signals produced by the trailer controller 106 may comprise a pulse width modulation (PWM). Examples of techniques used by controllers to, at least in part, produce or rely on pulse width modulated braking signals are described in U.S. Pat. No. 6,068,352 entitled “Microprocessor-Based Control for Trailer Brakes,” and U.S. Pat. No. 8,746,812 entitled “Brake Control Unit,” which are both incorporated by reference herein their entirety. In some examples, each of the brakes 118 are independently operable by the trailer controller 106 such that the trailer controller may apply the brakes 110 to the wheels 118 in any combination. In some examples, the trailer controller 106 uses braking signal from the towing vehicle 104 to control the operation of the brakes 110. Alternatively, in some examples, the trailer controller 106 uses braking signal from the towing vehicle 104 as an indicator of the braking intent of the driver and controls the operation of the brakes 110 based on the braking intent and the other signals received by the trailer controller 106 as described herein (e.g., from force transducers, inertia sensors, visual sensors, etc.). While electric brakes are described here, the brakes may alternatively be hydraulic brakes and the trailer controller 106 may be configured to control hydraulic brakes in a similar manner as described herein.

The batteries 112 may be in a large array in the base frame of the trailer 102. The batteries 112 may, for example, provide 100 kilowatt-hours (kWh) of energy. The battery controller 114 may (i) receive voltage signals from the batteries 112 and/or measurements from battery temperature sensors, etc., and (ii) provide diagnostic signals (e.g., state-of-charge (SoC), voltage level, temperature, etc.) to the trailer controller 106. The battery controller 114 controls charging (e.g., via regenerative braking, via a charging station, etc.) batteries and/or dissipating excess energy (e.g., produced during emergency brake assist, etc.). In some examples, the battery 112 is connected to a load with heat sink 120 to facilitate dissipating excess energy.

The electric trailer 102 is mechanically and communicatively coupled to the towing vehicle 104. In the illustrated example, a coupler 122 mechanically and, in some examples, communicatively couples the electric trailer 102 to a hitch 124 of the towing vehicle 104. The coupler 122 includes a force transducer 126 to measure a force between towing vehicle 104 and electric trailer 102 (e.g., when the speeds of the towing vehicle 104 and electric trailer 102 are not equal) (sometimes referred to as an “inter-trailer force”). In some examples, the trailer controller 106 may put the force transducer 126 into an idle, off, or low power mode when, for example, the coupler 122 is not mechanically connected to the hitch 124 of the towing vehicle 104. Examples of the coupler 122 and the force transducer 126 are described in U.S. patent application Ser. No. 17/672,152 entitled “Force Transducer for a Multifunction Trailer Controller,” which is herein incorporated by reference in its entirety.

In some examples, the electric trailer 102 includes one or more cameras 128A-128D (collectively “cameras 128”). The electric trailer 102 includes a rearview camera 128A to capture visual data behind the electric trailer 102. In such examples, the trailer controller 106 may transmit the visual data to the towing vehicle 104 to be, for example, displayed to on an in-console display (e.g., of the infotainment system, etc.). Alternatively, in some examples, the trailer controller 106 may be communicatively coupled to a processing unit (such as, a video processing module spate from the trailer controller 106) to control transmission of the visual data to the towing vehicle 104, to a server (e.g., a cloud-based server), and/or an application operating on a mobile device (as described below). In such a manner, the driver of the towing vehicle 104 may use the rearview camera 128A of the electric trailer 102 instead of its own rearview camera when backing up. The electric trailer 102 may include other cameras 128B-128D commutatively coupled to the trailer controller 106, that provide different views around the electric trailer 102 that may be communicated to the towing vehicle 104. For example, the electric trailer 102 may include (a) an interior camera 128B to view an interior of the electric trailer 102, (b) side cameras 128C to view sides of the electric trailer for, for example, blind spot detect, and/or (c) an undercarriage camera 128D to view below the electric trailer, etc. In some such examples, the trailer controller 106 may stitch (e.g., using image stitching algorithms, etc.) together images or feeds from multiple cameras 128A-128D before delivering the images or feeds to the towing vehicle 108.

In the illustrated examples, the electric trailer 102 includes one or more inertia sensors 130A and 130B (collectively “inertia sensors 130”). The trailer controller 106 may use measurements from the status sensor(s) 130A and 130B (e.g., an angle sensor and/or a lateral accelerometer, etc.) to determine lateral acceleration. In some examples, the trailer controller 106 detects roll or yaw in trailer 102 via angle sensor 130A and/or the range detection sensors. Depending on amplitude and frequency of sway, the trailer controller 106 applies brakes 110 to one or more of the wheels 210. The trailer controller 106 may also be coupled to a tilt angle sensor 130B that measures lateral tilt (e.g., one side of the trailer is higher than the other, etc.) that might be due to a flat tire, uneven terrain (e.g., the trailer 102 being on an uphill or downhill slope, etc.), etc.

The trailer 102 may include range detection sensors that detect ranges and speeds of vehicles or other objects around the trailer 102. The example range detection sensors may include one or more cameras, ultra-sonic sensors, sonar, LiDAR, RADAR, an optical sensor, or infrared devices. These range detection sensors can be arranged in and around trailer 102 in a suitable fashion. The trailer controller 106 may use the range detection sensors to, for example, supplement the collision avoidance system of the towing vehicle 104. In some examples, the trailer controller 106 provides intrusion detection signals (e.g., via a connection to the CAN bus of the towing vehicle 104, etc.) that report when a vehicle is detected in regions of interest (e.g., blind spots, tailgating spots, etc.) around the trailer 102. These intrusion detection signals may be configured to be interoperable with the collision avoidance system of the towing vehicle 104 such that the towing vehicle 104 uses the intrusion detection signals that originate from the trailer 102 as an extension of its own collision avoidance system. In a similar manner, the trailer controller 106 may be interoperable with the lane assist feature and/or the sway assist feature of the towing vehicle 104.

In some examples, the trailer 102 includes one or more sensors that measure the relationship between the back of the towing vehicle 104 and the front of the trailer 102 that are communicatively coupled to the trailer controller 102. The relationship may be the distance between the back of the towing vehicle 104 and the front of the trailer 102 at one or more points, and/or the relative angles between a plane defined by the back of the towing vehicle 104 and a plane defined by the front of the trailer 102. These sensors may be a physical sensor (e.g., a self-tensioning cable system that measure changes in length in a cable to keep the cable at the same tension, etc.) or an optical/sonic sensor (e.g., an infrared sensor, an ultrasonic sensor, a camera, etc.).

The trailer controller 106 includes circuitry (e.g., one or more processors, memory, drivers, etc.) to (i) control and/or communicate with sensors, motors, and other components of the electric trailers (e.g., electric brakes 110, battery controller 114, electric motor controllers 108, etc.), (ii) subsystems to communicate with the towing vehicle 104, and (iii) subsystems to control the motive, lighting, braking, and power management functions of the electric trailer 102. For example, the electric trailer 102 may (a) control the electric motor controllers 108 that drive the electric motors of the electric trailer 102, (b) perform diagnostics on systems of the electric trailer 102 and report the diagnostics, (c) monitor the status between the coupler 122 that is electrically, mechanically, and/or communicatively coupling electrical trailer 102 and the towing vehicle 104 and control the electric trailer 102 based on that status, (d) monitor the speed of each of the wheels 118 of the electric trailer 102, (e) monitor and control regenerative braking, (f) control the brakes 110 of the electric trailer 102, (g) provide an anti-lock braking system for the electric trailer 102, (h) monitor tire temperature, (i) monitor tire pressure, (j) perform power and/or battery management via the battery controller 114, (k) monitor power jack status and/or slideout room status, (l) perform gain control for the electric trailer 102, (m) monitor the force transducer 126 in the coupler 122, (n) monitor health of the components of the electric trailer 102, (o) couple the cameras 128, and/or (p) perform sway control, etc. Examples of systems and methods to perform gain control for the electric trailer 102 are described in U.S. Pat. No. 10,363,910 entitled “Automated Gain and Boost for a Brake Controller,” which is herein incorporated by reference in its entirety.

In the illustrated example, the trailer controller 106 is communicatively coupled with a controller private node 130 on the towing vehicle 104. The trailer controller 106 establishes a wired connection and/or a wireless connection with the controller private node 130. In some examples, the trailer controller 106 establishes both the wired connection (e.g., via the coupler 122, etc.) and the wireless connection with the controller private node 130 to provide communication redundancy. In some examples, the trailer controller 106 may have multiple available wireless connections (e.g., Bluetooth, Wi-Fi, Z-wave, etc.) to facilitate configurably establishing a wireless connection with different configurations of the controller private node 130. In some examples, the trailer controller 106 includes redundant hardware for the wired and/or wireless connections to make the communication robust and fault tolerant.

In some examples, the trailer controller 106 includes multiple communication controllers (e.g., wireless communication controllers, etc.) to provide communication redundancy. For example, during normal operation, the trailer controller 106 may use one wired or wireless controller to communicate with the controller private node 130, and, if that wired or wireless controller fails or otherwise loses connection, the trailer controller 106 may then switch to a second wired or wireless controller to communicate with the controller private node 130. In some examples, the trailer controller 106 is communicatively coupled with a controller private node 130 via two wired connections to provide communication redundancy. In such examples, the two wired connections may be different types of wired connection (e.g., CAN bus, LIN bus, I2C connection, MIL-STD-1553 connection, RS-232 connection, 1-Wire connection, Ethernet connection, a custom connection, etc.). In some examples, some types of data (e.g., diagnostic codes, instructions, towing vehicle data, etc.) may ordinarily use the primary connection and some types of data (e.g., video data, etc.) may ordinarily use the secondary connection. In some such examples, if the primary connection fails, the trailer controller 106 may switch the types of data that ordinarily use the primary connection to the secondary connection and pause or otherwise limit the transmission of the types of data that ordinarily use the secondary connection. In some examples, if both connections were to fail or be disrupted, the trailer controller 106 executes a limited operation strategy until at least one of the connections is reestablished.

In some examples, when the trailer controller 106 is in a theft detection mode and the trailer controller 106 detects that a theft may be occurring, the trailer controller 106 may use the wireless communication controller to notify the owner (e.g., via an app 132 operating on a mobile device 134) and/or the authorities (e.g., the police, the sheriff, a third party security company, etc.) of the theft detection, and, in some examples, provide GPS coordinates. For example, the trailer controller may use a cellular connection to communicate with the owner and/or the authorities and provide coordinates over this communication. In some examples, the trailer controller 106 may configure its wireless communication controller as a beacon to broadcast its identity, an emergency message, and/or its GPS coordinates.

The controller private node 130 provides an interface between the trailer controller 106 and (a) a communication bus 136, electronic control units (ECUs) 138 of the towing vehicle 104 (e.g., an engine control unit, transmission control unit, a brake control module, etc.), and (c) the instrument panel and/or in-vehicle infotainment system (IVI) of the towing vehicle 104. The trailer controller 106 may receive data from the ECUs 138 and send data to the ECUs 138 on the communication bus 136 via the controller private node 130. Additionally, in some examples, the controller private node 130 may monitor and/or control a power connection between the electric trailer 102 and the towing vehicle 104 when one is present.

In some examples, the controller private node 130 provides for/cooperates with the trailer controller 106 to establish the secured wired connection and/or wireless connection to prevent, for example, ease dropping and/or man-in-the-middle attacked, etc. In some examples, the controller private node 130 and the trailer controller 106 may pair (e.g., establish a trusted relationship, etc.) such that the trailer controller 106 can recognized when it is connected to an authorized towing vehicle 104 and vice versa (e.g., via a handshake, etc.). The controller private node 130 facilitates security measures, such as theft detection, by establishing the trusted relationship between the controller private node 130 and the trailer controller 106. In some examples, the controller private node 130 may receive emergency instructions from the trailer controller 106. In some such examples, the controller private node 130 is configured to, in response to receiving an emergency instruction from the trailer controller 106, communicate with the relevant ECUs 138 to prevent the towing vehicle 104 from performing an act that would be detrimental to the trailer 102 based on the current status of the trailer 102. For example, the trailer controller 106 may provide an instruction to prevent the towing vehicle 104 from disengaging from the parking gear when the power jack is in an extended position. In such an example, in response to receiving an instruction that the power jack is in an extended position, the controller private node 130 may instruct the transmission control unit to prevent the towing vehicle 104 form shifting from the parking gear and/or will provide a warning notification to the instrument cluster and/or to a smart device (such as a smartphone, tablet or the like). In some examples, the controller private node 130 and the trailer controller 106, after establishing a trusted relationship (e.g., an exchange of secret keys, etc.), use encryption (e.g., private key encryption, etc.) to wired and/or wireless communicate with each other such that a third party could not intercept unencrypted information being exchanged.

The trailer controller 106 controls the motive force of the trailer 102 in reference to, but independent of, the towing vehicle 104 and supports the towing vehicle 104 during scenarios with load peaks, such as during transition from a static state to a kinetic state and when the towing vehicle is driving uphill. In towing vehicles with combustion engines, this control by the trailer controller 106 may improve fuel economy of the towing vehicle compared to traditional towing arrangements. In electric towing vehicles, this control by the trailer controller 106 may improve the range of the electric vehicle on a charge compared to traditional towing arrangements.

To help control the electric trailer and improve mileage of the towing vehicle 104, the trailer controller 106 controls the motive force of the electric trailer such that the inter-trailer force is maintained for a trailer load that is lower than the permissible total weight of the trailer (sometimes referred to as the “max weight”) (e.g., controls the electric trailer on its actual or approximate weight, not its maximum weight). The weight of the trailer 102 (e.g., the current weight, the max weight, etc.) may be input by a user via the dashboard IVI and/or the mobile app 132 communicative coupled to the trailer controller 106. As used herein, when the inter-trailer force is towards the towing vehicle 104 (e.g., when trailer 102 travels faster than the towing vehicle 104), the inter-trailer force may be referred to as a “thrusting force.” When the inter-trailer force is towards the trailer 102 (e.g., when trailer 102 travels faster slower than or is being pulled by the towing vehicle 104), the inter-trailer force may be referred to as a “pulling force.” For example, when the towing vehicle 104 applies its brakes, before the trailer controller 106 can react to slow the trailer 102, the inter-trailer force may be a thrusting force.

The trailer controller 106 is configured to maintain equilibrium between the thrusting force and the pulling force (e.g., the inter-trailer force being zero). Because of the dynamic conditions of towing a trailer, the trailer controller 106 is configured react to those dynamic conditions such that the trailer controller 106 starts to react to changing conditions, based on its own data about those conditions, before receiving communication from the towing vehicle 104. As illustrated in FIG. 2, the trailer controller 106 is configured to maintain the inter-trailer force 200 within a band defined by an upper threshold 202 (e.g., for the thrusting force) and a lower threshold 204 (e.g., for the pulling force). In such a manner, the trailer controller 106 is configured to, as described herein, maintain an approximately zero inter-trailer force as possible by controlling the service brakes 110, the electric motors (via the wheel controllers 108), and the regenerative braking (e.g., via the battery controller 114) of the trailer 102. In response the inter-trailer force crossing one of the thresholds, the trailer controller 106 takes a corresponding action until the inter-trailer force is below the triggering threshold. For example, when the inter-trailer force crosses the upper threshold, the trailer controller 106 may actuate the service brakes 210 and/or engages the regenerative braking. As another example, when the inter-trailer force crosses the lower threshold, the trailer controller 106 may drive the wheels 118 of the trailer faster. The upper threshold 200 and the lower threshold 202 is based on (i) the actual load of the trailer and (ii) the current speed of the trailer. As such, the thresholds 202 and 204 may dynamically change in response to changes in speed. For example, at higher speeds, the trailer controller 106 may tighten the threshold band such that the time the inter-trailer force is a pulling force is minimized. In some examples, the threshold band defined by the upper threshold 202 and the lower threshold 204 may not be centered on a zero force (sometimes referred to as “equilibrium”). In some such examples, the threshold for the pulling force (e.g., the lower threshold 204) may be closer to equilibrium than the threshold for the thrusting force (e.g., the upper threshold 202). In some example, the trailer controller 106 uses hysteresis (illustrated as lines 206 and 208) to reduce the controller's response to noise and slow transitions. The amount of hysteresis set by the trailer controller 106, as represented by lines 206 and 208, may be based on the actual weight of the trailer 102, and thus dynamically change. For examples, the amount or factor of the hysteresis may be higher when the trailer 102 is heavier. In the illustrated example of FIG. 2, the trailer controller 106 takes remedial action (e.g., applies the service brakes 110, engages regenerative braking, etc.) when the inter-trailer force 200 crosses the upper threshold 202 and continues in its remedial action until the inter-trailer force 200 drops below the corresponding hysteresis point 206.

To maintain the inter-trailer force within the threshold band, the trailer controller 106 controls the service brakes 110 (e.g., to slow the trailer) or the wheel controllers 108 (e.g., to increase the speed of the trailer) of the trailer 102 using the power stored in the batteries 112 of the trailer 102. If the trailer controller 106 detects an inter-trailer force greater than the upper threshold 202, the trailer controller 106 applies braking such that the force is reduced to less than the upper threshold 202 (or, in some examples, below the corresponding hysteresis point 206). Similarly, if the trailer controller 106 an inter-trailer force less than the lower threshold 204 is detected, the trailer controller 106 applies a driving signal to the motor controllers 108 to increase the speed of the trailer 102 to bring the inter-trailer force above the lower threshold 204 (or, in some examples, above the corresponding hysteresis point 208). In some examples, if the inter-trailer force is below a baseline threshold for a predetermined amount of time, the controller determine that the trailer is not connected. The trailer controller 106 determines the amount of braking or the amount of speed increase is needed to bring the inter-trailer below the triggering threshold 202 and 204. The trailer controller 106 calculates the required change in speed necessary to move the inter-trailer force to equilibrium based on the inter-trailer force, the mass of the trailer 102, the speed of the trailer 102, and/or the acceleration of the trailer 102. In some examples, instead of abruptly adjusting the speed of the trailer 102, the trailer controller 106 incrementally adjust the speed of the trailer 102 by a change rate (e.g., the rate at which the braking force is increase, the rate at which the speed of the trailer is increased, etc.). In such examples, the trailer controller 106 recalculates the required change in speed necessary to move the inter-trailer force to equilibrium as the trailer controller 106 incrementally adjust the speed of the trailer 102 to, for example, adjust to dynamic changes to the speed of, for example, towing vehicle 104 (e.g., as indicated by the inter-trailer force). In some examples, the change rate is based on the current speed of the trailer 102, the current speed of the towing vehicle 104, and of the magnitude of the inter-trailer force. In some such examples, the change rate is greater the faster the trailer 102 is moving and/or the greater the magnitude of the inter-trailer force. Because the trailer 102 is providing or substantially providing its own motive force, even relatively light vehicles having a low towing capacity and/or a chassis not designed for towing is able to pull disproportionally large and heavy trailers.

The trailer 102 includes the one or more batteries 112 to provide power to the electric motors that drive the wheels 118 (as controlled by the wheel controllers 108) and the brakes separate from the towing vehicle 104. The trailer controller 106, from time-to-time, uses regenerative braking to slow the trailer 112 and charge the batteries 112. The trailer controller 106 may use passive braking (e.g., regenerative braking) and active braking (e.g., through application of the service brakes 110), singly or in combination, to slow the trailer 102. In some examples, the trailer controller 106 may operate the brakes 110 individually or in different combinations (e.g., the brakes 110 on each of the two sides separately, etc.). The trailer controller 106 may operate different brakes 110 using different braking. For example, the trailer controller 106 may actively brake the front two wheels 118 and may passively brake the back two wheels 118. The trailer controller 106, via the battery controller 114, monitors the state of the batteries 112 to determine how much passive braking to use when slowing the trailer 102. The amount of passive braking used is based on the SoC of the batteries 112, wherein more passive braking is used when the batteries have a greater capacity to accept (e.g., be recharged by) the energy generated through passive braking (e.g., when the charge of the battery is lower). Additionally, in some examples, the amount of passive braking used is based on the SoC of the batteries 112 being below a threshold set to ensure that the batteries 112 maintain enough power to fully engage the service brakes 110 at any time.

In some examples, the trailer controller 106 controllers the speed of the trailer 102 to enhance the maneuverability of the towing vehicle 104 and trailer 102. In some such examples, the trailer controller 106 may automatically actuate one or more of the service brakes 110 to assist when cornering to increase the traction of the rear axle the towing vehicle 104. In some examples, the trailer controller 106 controls the electric motors (e.g., via the wheel controllers 108) of the two sides of the trailer separately to steer the trailer 102 in cooperation with the towing vehicle 104 to (i) maintain the inter-trailer force and (ii) reduce the load on the read axel of the towing vehicle 104. In some examples, the trailer controller 106 is coupled to one or more sensors (e.g., camera(s), infrared sensors, LiDAR, etc.) to detect an articulation angle between the towing vehicle 104 and the trailer 102 such that control of the trailer 102 during cornering may be done independently of the towing vehicle 104 (e.g., without instructions from the towing vehicle 104 on how to control the motive functions of the trailer 102, etc.). In some examples, the trailer controller 106 may with assists the turning of the trailer 102 by controlling the speed of the wheels 118 (e.g., via the wheel controllers 108) on different sides of the trailer 102 at different speeds. For example, the trailer controller 106 may cause the wheels 118 corresponding to the side of the trailer 102 on the interior of the turn to move slower than the wheels 118 on the other side.

In some examples, the trailer controller 106 includes control software which includes a system model of the trailer 102 to predict the forces that will act on the trailer 102 and to control the brakes 110 and the electric motors (e.g., via the wheel controllers 108) accordingly based on the observed operation of the towing vehicle (e.g., via sensors 130, via cameras 128, via data received from the towing vehicle 104, etc.). The system model outputs controls for the brakes 110 and the electric motors based on inputs from (i) wheel speed sensors associated with the wheels 118 of the trailer, (ii) lateral acceleration of the trailer 102 (e.g., as measured by the wheel speed sensors and/or accelerometers, etc.), (iii) the articulation angle between the towing vehicle 104 and trailer 102, (iv) the pitch and yaw of the trailer 102 (e.g., as measured by a gyroscope, etc.), and/or (v) the inter-trailer force. In such examples, the trailer controller 106 uses the system model to predict and correct the dynamics of the trailer 102 when the towing vehicle 104 is maneuvering by, for example adjusting, the speed of the wheels 118 (e.g., collectively or individually) as part of an electronic stability system. For example, the system model may use input from a yaw-rate sensor to measure rotation around the vertical axis of the trailer and the lateral acceleration of the trailer. The system model may calculate the actual state of the trailer 102 and the desired state of the trailer 102 (e.g., the inter-trailer force, the speed, the pitch, the yaw, the direction of travel, etc.) and, when the actuate state and the desired state differ, control the brakes 118 and/or the electric motors to eliminate that difference. The system model may determine if these corrections are necessary multiple times a second (e.g., 20 times per second, 30 times per second, etc.).

FIG. 3 is a flowchart of an example method to control the inter-trailer force between the trailer 102 and the towing vehicle 104. The trailer controller 106 monitors the inter-trailer force via the force transducer 126 (block 302). The trailer controller 106 determines whether the inter-trailer force crosses the upper threshold 202 or the lower threshold 204 (block 304). When the inter-trailer force does not cross the upper threshold 202 or the lower threshold 204 (“NO” at block 304), the trailer controller 106 continues to monitor the inter-trailer force (block 302). Otherwise, when the inter-trailer force crosses one of the upper threshold 202 or the lower threshold 204 (“YES” at block 304), the trailer controller 106 calculates a target change in speed of the trailer 102 so the inter-trailer force reenters the threshold band defined by the upper threshold 202 or the lower threshold 204 (block 306). The trailer controller determines a charge rate to incrementally change the speed of the trailer 102 (block 308). In some examples, the change rate is based on the speed of the trailer 102 and the mass of the trailer 102. The trailer controller 106 then acts to change the speed of the trailer 102 according to the change rate (block 310). For example, the trailer controller 106 may gradually slow the trailer 102 by using active and/or passive braking or may gradually increase the speed of the trailer by instructing the electric motors to increase the speed of the wheels 118. After changing the speed of the trailer 102 according to the change rate, the trailer controller 106 determines if the inter-trailer force has reentered the threshold band (block 312). When the inter-trailer force has reentered the threshold band (“YES” at block 312), the trailer controller 106 continues to monitor the inter-trailer force (block 302). Otherwise, when the inter-trailer force has not reentered the threshold band (“NO” at block 312), the trailer controller 106 calculates a target change in speed of the trailer 102 so the inter-trailer force reenters the threshold band (block 306).

FIG. 4 is a flowchart of an example method to control the inter-trailer force between the trailer 102 and the towing vehicle 104. The trailer controller 106 monitors the inter-trailer force via the force transducer 126 (block 402). The trailer controller 106 determines whether the inter-trailer force is (a) a thrusting force, (b) a pulling force, or (c) at equilibrium (block 404). When the inter-trailer force is at equilibrium (“EQUILIBRIUM” at block 404), the trailer controller 106 monitors the inter-trailer force via the force transducer 126 (block 402).

When the inter-trailer force is a thrusting force (“THRUSTING” at block 404), the trailer controller 106 determines whether the inter-trailer force crosses the upper threshold 202 (block 406). When the inter-trailer force does not cross the upper threshold 202 (“NO” at block 406), the trailer controller 106 continues to monitor the inter-trailer force (block 402). Otherwise, when the inter-trailer force crosses the upper threshold 202 (“YES” at block 406), the trailer controller 106 calculates a target change in speed of the trailer 102 to reduce the speed of the trailer 102 (block 408). The trailer controller determines a charge rate to incrementally change the speed of the trailer 102 (block 410). The trailer controller 106 then slows the trailer 102 according to the change rate (e.g., via active and/or passive braking) (block 412). After slowing the trailer 102 according to the change rate, the trailer controller 106 determines if the inter-trailer force is below the upper threshold 202 (block 414). When the inter-trailer force is below the upper threshold 202 (“YES” at block 414), the trailer controller 106 continues to monitor the inter-trailer force (block 402). Otherwise, when the inter-trailer force is not below the upper threshold 202 (“NO” at block 414), the trailer controller 106 calculates a target change in speed of the trailer 102 so the inter-trailer force becomes below the upper threshold (block 408).

When the inter-trailer force is a pushing force (“PUSHING” at block 404), the trailer controller 106 determines whether the inter-trailer force crosses the lower threshold 204 (block 416). When the inter-trailer force does not cross the lower threshold 204 (“NO” at block 416), the trailer controller 106 continues to monitor the inter-trailer force (block 402). Otherwise, when the inter-trailer force crosses the lower threshold 204 (“YES” at block 426), the trailer controller 106 calculates a target change in speed of the trailer 102 to increase the speed of the trailer 102 (block 418). The trailer controller determines a charge rate to incrementally change the speed of the trailer 102 (block 420). The trailer controller 106 then increases the speed of the trailer 102 according to the change rate (e.g., via wheel controllers 108) (block 422). After increasing the speed of the trailer 102 according to the change rate, the trailer controller 106 determines if the inter-trailer force is above the lower threshold 204 (block 424). When the inter-trailer force is above the lower threshold 204 (“YES” at block 424), the trailer controller 106 continues to monitor the inter-trailer force (block 402). Otherwise, when the inter-trailer force is not above the lower threshold 204 (“NO” at block 424), the trailer controller 106 calculates a target change in speed of the trailer 102 so the inter-trailer force raises above the lower threshold (block 418).

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of A and B, then there may be inventive subject matter in the combination of A and B, A alone, or B alone, unless otherwise stated herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What I claim is:

1. A trailer controller assembly comprising:
a force transducer configured to measure a force between a trailer and a towing vehicle;
at least one brake controller configured to control at least one brake of the trailer; and
a controller communicatively coupled to the force transducer, wherein the controller is configured to adjust the speed of the trailer based on the measured force.

2. The trailer controller assembly of claim 1, wherein the trailer controller further comprises at least one wheel speed sensor and at least one independent drive for at least one wheel of the trailer.

3. The trailer controller assembly of claim 2, wherein the independent drive comprises an electric motor with pulse width modulation (PWM) control.

4. The trailer controller assembly of claim 2, wherein the trailer controller is configured to use a combination of braking and the independent drive to gradually adjust the speed of the trailer.

5. The trailer controller assembly of claim 1, wherein the trailer controller is further configured to determine whether an inter-trailer force crosses an upper threshold or a lower threshold.

6. The trailer controller assembly of claim 4, wherein the trailer controller is further configured to calculate a target change in speed of the trailer if the inter-trailer force crosses either the upper threshold or the lower threshold to bring the inter-trailer force between the upper threshold and the lower threshold.

7. The trailer controller assembly of claim 1, wherein the trailer controller determines a charge rate based on the speed and mass of the trailer to incrementally change the speed of the trailer.

8. A trailer controller assembly comprising:
a force transducer configured to measure a force between a trailer and a towing vehicle;
a controller communicatively coupled to the force transducer, wherein the controller is configured to adjust the speed of the trailer based on the measured force;
at least one wheel controller associated with at least one wheel of the trailer, the at least one wheel controller further comprising:
an independent drive for the at least one wheel of the trailer to drive the at least one wheel of the trailer; and
at least one brake controller configured to control at least one brake of the trailer.

9. The trailer controller assembly of claim 8, wherein the independent drive comprises an electric motor with pulse width modulation (PWM) control.

10. The trailer controller assembly of claim 8, wherein the trailer controller is configured to use a combination of braking and the independent drive to gradually adjust the speed of the trailer.

11. The trailer controller assembly of claim 8, wherein the trailer controller is further configured to determine whether an inter-trailer force crosses an upper threshold or a lower threshold.

12. The trailer controller assembly of claim 11, wherein the trailer controller is further configured to calculate a target change in speed of the trailer if the inter-trailer force crosses either the upper threshold or the lower threshold to bring the inter-trailer force between the upper threshold and the lower threshold.

13. The trailer controller assembly of claim 8, wherein the trailer controller determines a charge rate based on the speed and mass of the trailer to incrementally change the speed of the trailer.

14. A method for maintaining inter-trailer force with a trailer controller assembly, the method comprising:
measuring the force between a trailer and a towing vehicle using a force transducer;
communicatively coupling the force transducer and a controller within the trailer controller assembly;
adjusting the speed of the trailer by the controller utilizing a brake controller and at least one wheel controller based on the measured inter-trailer force.

15. The method of claim 14, wherein the at least one wheel controller comprises of at least one wheel speed sensor and at least one independent drive for the at least one wheel of the trailer.

16. The method of claim 15, wherein the independent drive comprises an electric motor with pulse width modulation (PWM) control.

17. The method of claim 14, wherein the trailer controller is configured to use a combination of braking and the at least one independent drive to gradually adjust the speed of the trailer.

18. The method of claim 14, wherein the trailer controller is further configured to determine whether an inter-trailer force crosses an upper threshold or a lower threshold.

19. The method of claim 18, wherein the trailer controller is further configured to calculate a target change in speed of the trailer if the inter-trailer force crosses either the upper threshold or the lower threshold to bring the inter-trailer force between the upper threshold and the lower threshold.

20. The method of claim 14, wherein the trailer controller determines a charge rate based on the speed and mass of the trailer to incrementally change the speed of the trailer.
